(19) United States
(12) Patent Application Publication
(10) Pub. No.: US 2024/0427298 A1
(43) Pub. Date: Dec. 26, 2024

(54) METHOD AND CONTROL DEVICE FOR CONTROLLING A TECHNICAL SYSTEM

(71) Applicant: Siemens Aktiengesellschaft, München (DE)

(72) Inventors: Phillip Swazinna, Neufahrn (DE); Steffen Udluft, Eichenau (DE); Holger Schöner, München (DE); Clemens Otte, München (DE)

(21) Appl. No.: 18/700,342

(22) PCT Filed: Sep. 30, 2022
(86) PCT No.: PCT/EP2022/077309

§ 371 Date: Apr. 11, 2024

(30) Foreign Application Priority Data
Oct. 27, 2021 (EP) 21205071.0

(51) Int. Cl. G05B 13/02; G06N 20/00

(52) U.S. Cl. CPC G05B 13/028; G06N 20/00

(57) ABSTRACT

To control a technical system, training data are read in, a training dataset, including in each case a state dataset, an action dataset and a resulting performance value of the technical system. Using the training data, a first machine learning module is trained to reproduce a resulting performance value on the basis of a state dataset and an action dataset. State datasets are also supplied to different deterministic control agents and resulting output data are fed into the trained first machine learning module as action data sets. Depending on performance values output by the trained first machine learning module, several control agents are then selected. The technical system is controlled in each case by the selected control agents, wherein further state datasets, action datasets and performance values are captured and added to the training data. Using the training data, the method steps are repeated.

### CROSS-REFERENCE TO RELATED APPLICATIONS

This application claims priority to PCT Application No. PCT/EP2022/077309, having a filing date of Sep. 30, 2022, which claims priority to EP application Ser. No. 21205071.0, having a filing date of Oct. 27, 2021, the entire contents both of which are hereby incorporated by reference.

### FIELD OF TECHNOLOGY

The following relates to a method and control device for controlling a technical system.

### BACKGROUND

Data-driven machine learning methods are increasingly being used for controlling complex technical systems, such as e.g., gas turbines, wind turbines, steam turbines, motors, robots, chemical reactors, milling machines, production plants, cooling plants or heating plants. In embodiments, the method involves in particular artificial neural networks being trained by reinforcement learning methods to generate a state-specific control action for a respective state of the technical system in order to control the technical system, the control action optimizing a performance of the technical system. Such a control agent optimized for control of a technical system is frequently also referred to as a policy, or as an agent for short.

Successfully optimizing a control agent generally requires large volumes of operating data relating to the technical system as training data. The training data should cover the operating states and other operating conditions of the technical system as representatively as possible.

In many cases, such training data are in the form of databases storing operating data recorded on the technical system. Such stored training data are frequently also referred to as batch training data or offline training data. Based on experience, the success of a training is generally dependent on the extent to which the possible operating conditions of the technical system are covered by the batch training data. Accordingly, it can be expected that control agents trained using batch training data behave unfavorably in operating states for which only a handful of batch training data were available.

To improve the control behavior in regions of the state space that have little coverage by training data, the publication “Deployment-Efficient Reinforcement Learning via Model-Based Off-line Optimization” by Tatsuya Matsushima, Hiroki Furuta, Yutaka Matsuo, Ofir Nachum and Shxiang Gu on https://arxiv.org/abs/2006.03647 (retrieved on Oct. 8, 2021) proposes a recursive learning method. This method yields stochastic policies, however, which can sometimes indicate very different and not reliably predictable control actions for the same operating state. Although the state space can be explored efficiently in this way, stochastic policies such as these are not permissible on many technical systems insofar as they cannot be reliably validated in advance.

### SUMMARY

An aspect relates to a method and a control device for controlling a technical system that permit exploration of a state space of the technical system and in so doing use deterministic control agents.

A technical system is controlled by reading in training data, a respective training dataset comprising a state dataset that specifies a state of the technical system, an action dataset that specifies a control action and a performance value of the technical system that results from an application of the control action. The term control will also be understood to mean automatic control of the technical system. The training data are used to train a first machine learning module to use a state dataset and an action dataset to reproduce a resulting performance value. Furthermore, a multiplicity of different deterministic control agents are each supplied with state datasets, and resulting output data are fed into the trained first machine learning module as action datasets. Performance values output by the trained first machine learning module are then taken as a basis for selecting multiple instances of the control agents. According to embodiments of the invention, the technical system is respectively controlled by the selected control agents, with further state datasets, action datasets and performance values being captured and added to the training data. The thus augmented training data are used to repeat the above method steps from the training of the first machine learning module onward.

To perform the method according to embodiments of the invention, there is provision for a corresponding control device, a computer program product (non-transitory computer readable storage medium having instructions, which when executed by a processor, perform actions) and a computer-readable, nonvolatile, storage medium.

In embodiments, the method according to the invention and the control device according to embodiments of the invention can be carried out, or implemented, by one or more computers, processors, application-specific integrated circuits (ASICs), digital signal processors (DSPs) and/or so-called “field programmable gate arrays” (FPGAs), for example.

An advantage of embodiments of the invention can be seen in particular in that the control of the technical system by multiple different and iteratively adapted control agents permits effective exploration of a state space of the technical system. This allows adverse effects of regions of the state space that have poor coverage by training data to be effectively reduced. At the same time, a restriction to deterministic control agents allows validation problems of stochastic control agents to be avoided.

According to embodiments of the invention, a second machine learning module may be trained, or can be trained using the training data, to use a state dataset to reproduce an action dataset. The control agents can each be compared with the second machine learning module, a respective distance that quantifies a dissimilarity between the respective control agent and the second machine learning module being ascertained. A control agent having a lesser distance from the second machine learning module can thus be selected preferentially over a control agent having a greater distance. The distance ascertained, in particular in the case of artificial neural networks, can be a distance between neural weights of a respective control agent and normal weights of the second machine learning module. In an embodiment, an optionally weighted Euclidean distance between vector representations of these neural weights can be ascertained.

In particular, the distance of a respective control agent can be compared with a threshold value. The respective control agent can then be excluded from the selection if the threshold value is exceeded. A precondition for the selection of a control agent can thus be formulated as |N2−NP|<=TH, where TH is the threshold value, N2 is a vector of neural weights of the second machine learning module and NP is a vector of neural weights of the control agent in question. This allows the control of the technical system to be restricted to control agents that do not differ all too much from the second machine learning module. In many cases, control agents that output inadmissible or seriously disadvantageous control actions can thus be effectively excluded.

The threshold value can be increased when the method steps are repeated. This allows the exploration of the state space of the technical system to be improved over the course of iterative training.

According to embodiments of the invention, the multiplicity of control agents can be generated by a model generator. In this regard, multiple instances of the generated control agents can be compared with other control agents, a respective distance that quantifies a dissimilarity between the compared control agents being ascertained. A control agent having a greater distance from one or more other control agents can then be selected and/or generated preferentially over a control agent having a lesser distance. It is therefore possible to provide control agents that have a high level of diversity among one another. This allows different regions of the state space to be explored in parallel and therefore more efficiently.

According to embodiments of the invention, the control agents can be trained, using the training data, to use a state dataset to reproduce an action dataset that specifies a performance-optimizing control action. Besides the selection, additional training such as this can in many cases improve the performance of the selected control agents further.

According to embodiments of the invention, a respective training dataset can comprise a subsequent state dataset that specifies a subsequent state of the technical system resulting from an application of a control action. The first machine learning module can then be trained, using the training data, to use a state dataset and an action dataset to reproduce a resulting subsequent state dataset. Furthermore, a second machine learning module can be trained, using the training data, to use a state dataset to reproduce an action dataset. The trained first machine learning module can then ascertain a subsequent state dataset for an action dataset output by the respective control agent and feed the subsequent state dataset into the trained second machine learning module. A resultant subsequent action dataset can in turn be fed into the trained first machine learning module together with the subsequent state dataset. Finally, a resultant performance value for the subsequent state can be taken into consideration for the selection of the control agents. This allows a state and a control action to be gradually extrapolated into the future or predicted, with the result that a control trajectory comprising multiple time steps can be ascertained. Such an extrapolation is frequently also referred to as a rollout or virtual rollout. A performance cumulated over multiple time steps can then be calculated for the control trajectory and assigned to the control action at the start of the trajectory. A cumulated performance such as this is frequently also referred to as “return” in the context of reinforcement learning. To calculate the return, the performance values ascertained for future time steps can be discounted, i.e. provided with weights that become smaller for each time step.

### BRIEF DESCRIPTION

Some of the embodiments will be described in detail, with references to the following Figures, wherein like designations denote like members, wherein:

FIG. 1 illustrates a control device according to embodiments of the invention when controlling a technical system,

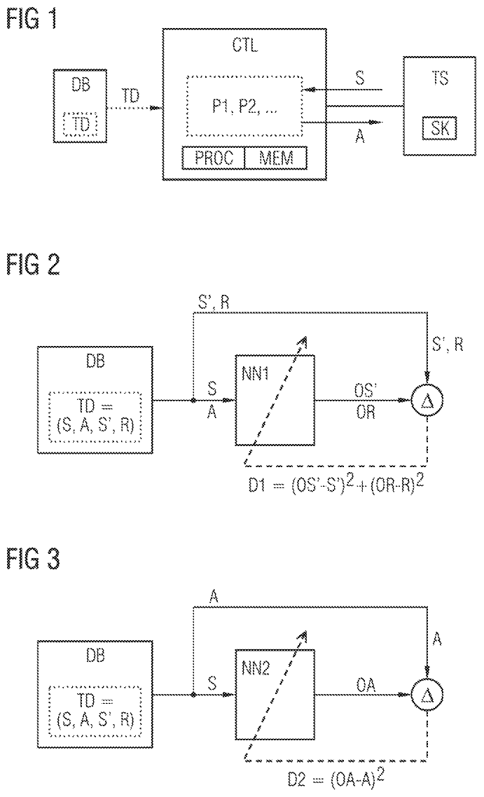

FIG. 2 illustrates a training of a first machine learning module for the technical system;

FIG. 3 illustrates a training of a second machine learning module for the technical system;

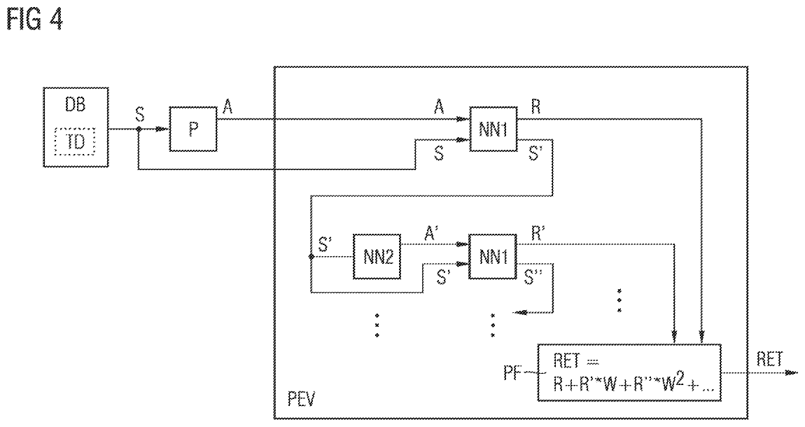

FIG. 4 illustrates an ascertainment of a performance of a control agent; and

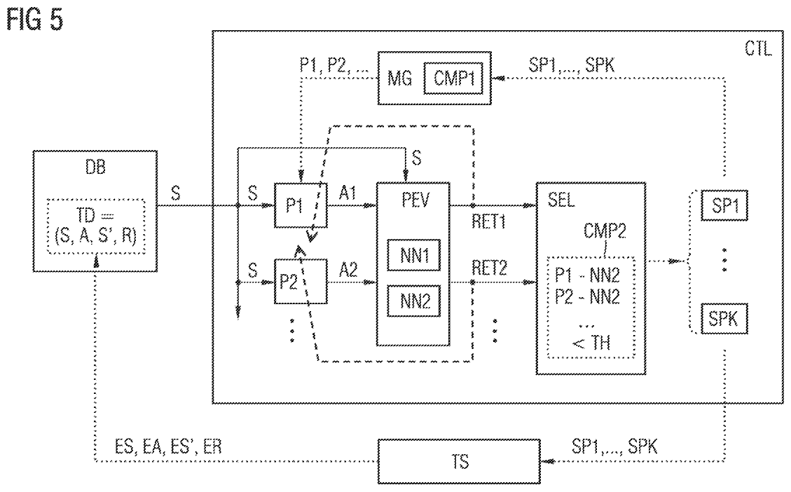

FIG. 5 illustrates an optimization of control agents for the technical system.

### DETAILED DESCRIPTION

FIG. 1 illustrates a control device CTL according to embodiments of the invention when controlling a technical system TS, e.g., a gas turbine, a wind turbine, a steam turbine, a chemical reactor, a milling machine, a machine tool, a production plant, a factory, a robot, a motor vehicle, a motor, a cooling plant, a heating plant, a power plant or another machine, another device or another plant. In particular, a component or a subsystem of an assembled technical system can also be regarded as a technical system TS.

The technical system TS has a sensor system SK for continually capturing and/or measuring system states or subsystem states of the technical system TS. It will be assumed for the present exemplary embodiment that the technical system TS controlled is a machine tool.

In FIG. 1, the control device CTL is shown externally to the technical system TS and is coupled thereto. Alternatively, the control device CTL may also be wholly or partly integrated in the technical system TS.

The control device CTL has one or more processors PROC for carrying out method steps of the control device CTL and has one or more memories MEM coupled to the processor PROC for storing the data that are to be processed by the control device CTL.

Furthermore, the control device CTL has one or more deterministic control agents P1, P2, . . . for controlling the technical system TS. In the present exemplary embodiment, there is provision for multiple control agents P1, P2, . . . , which are each implemented as an artificial neural network and can be trained using reinforcement learning methods. Such a control agent is frequently also referred to as a policy, or an agent for short. A deterministic control agent is characterized in that it outputs identical output data for identical input data.

The control agents P1, P2, . . . and therefore the control device CTL are trained and/or selected in a data-driven manner using training data in advance and are thus configured to control the technical system TS in an optimized manner. The training data for training and/or selecting the control agents P1, P2, . . . are taken from a database DB that stores the training data in the form of a multiplicity of training datasets TD. The stored training datasets TD are recorded on the technical system TS or a similar technical system in advance and/or generated by simulation or in a data-driven manner.

On the basis of these training data, the control agents P1, P2, . . . are trained and/or selected to ascertain a control action for a respective predefined state of the technical system TS, the control action optimizing a performance of the technical system TS. The performance to be optimized can relate in particular to a power, a yield, a speed, a weight, a running time, a precision, an error rate, a resource consumption, an effectiveness, an efficiency, pollutant emissions, a stability, a wear, a service life, a physical property, a mechanical property, an electrical property, a secondary condition to be observed or other target variables of the technical system TS or of one of its components that need to be optimized.

A sequence of this training is explained in more detail below.

After the training has concluded, the trained and/or selected control agents P1, P2, . . . can be used to control the technical system TS in an optimized manner. For this purpose, current operating states and/or other operating conditions of the technical system TS are continually measured or otherwise ascertained by the sensor system SK and transferred from the technical system TS to the control device CTL in the form of state datasets S. Alternatively or additionally, at least some of the state datasets S can be ascertained by simulation by a simulator, in particular a digital twin of the technical system TS.

A respective state dataset S specifies a state of the technical system TS and is represented by a numerical state vector. The state datasets S can comprise measurement data, sensor data, environment data or other data that arise during the operation of the technical system TS or that influence operation, in particular data about actuator positions, forces occurring, power, pressure, temperature, valve positions, emissions and/or resource consumption of the technical system TS or of one of its components. In the case of production plants, the state datasets S can also relate to a product quality or other product properties.

The state datasets S transferred to the control device CTL are fed into one or more of the trained control agents P1, P2, . . . as input data. The control agents P1, P2, . . . can be alternately used to control the technical system TS or actuated on the basis of a state or other operating conditions of the technical system TS.

A respectively supplied state dataset S is used by a currently controlling control agent P1 or P2, . . . to generate a performance-optimizing control action in the form of an action dataset A. The action dataset A specifies a control action that can be carried out on the technical system TS. In particular, the action dataset A can specify manipulated variables of the technical system TS, e.g., for adjusting a gas supply for a gas turbine or for executing a motion trajectory for a robot.

The generated action datasets A are transferred from the control device CTL to the technical system TS and executed by the latter. In this way, the technical system TS is controlled in a manner optimized for the current operating state.

FIG. 2 illustrates a training of a first machine learning module NN1 for the technical system TS. The first machine learning module NN1 can be trained in a data-driven manner and is intended to model a state transition when a control action is applied to a predefined state of the technical system TS. Such a machine learning module is frequently also referred to as a transition model or system model.

The first machine learning module NN1 can be implemented in the control device CTL or wholly or in part externally thereto. In the present exemplary embodiment, the first machine learning module NN1 is implemented as an artificial neural network, in particular as a neural feedforward network.

The first machine learning module NN1 is intended to use the training datasets TD contained in the database DB to be trained to use a respective state and a respective control action to predict a subsequent state of the technical system TS that results from application of the control action and a resultant performance value as accurately as possible.

The first machine learning module NN1 is trained using the training datasets TD stored in the database DB. A respective training dataset TD in this instance comprises a state dataset S, an action dataset A, a subsequent state dataset S′ and a performance value R. As already mentioned above, the state dataset S each specify a state of the technical system TS and the action datasets A each specify a control action that can be performed on the technical system TS. Accordingly, a respective subsequent state dataset S′ specifies a subsequent state that results from application of the respective control action to the respective state, i.e. a system state of the technical system TS that is adopted in a subsequent time step. Finally, the respective associated performance value R quantifies the respective performance of an execution of the respective control action in the respective state. As already indicated above, the performance value R in this instance can relate in particular to a resulting power, a resulting emission value, a resulting resource consumption, a resulting product quality and/or other operating parameters of the technical system TS that result from performance of the control action. In the context of machine learning, such a performance value is also referred to by the term reward or—complementarily—costs or loss.

The first machine learning module NN1 is trained by supplying it with state datasets S and action datasets A as input data. The first machine learning module NN1 is intended to be trained in such a way that the output data therefrom reproduce a respective resulting subsequent state and a respective resulting performance value as accurately as possible. The training is carried out by a supervised machine learning method.

A training in this context is intended to be understood generally to mean an optimization of a mapping of input data, here S and A, of a machine learning module to the output data therefrom. This mapping is optimized based on predefined, learnt and/or learnable criteria during a training phase. The criteria used can be, in particular in the case of prediction models, a prediction error and, in the case of control models, a success of a control action. By way of example, the training can adjust, or optimize, networking structures of neurons of a neural network and/or weights of connections between the neurons in such a way that the predefined criteria are satisfied as well as possible. The training can therefore be regarded as an optimization problem. A large number of efficient optimization methods are available for such optimization problems in the field of machine learning, in particular gradient-based optimization methods, gradient-free optimization methods, back propagation methods, particle swarm optimizations, genetic optimization methods and/or population-based optimization methods.

In particular artificial neural networks, recurrent neural networks, convolutional neural networks, perceptrons, Bayesian neural networks, autoencoders, variational autoencoders, Gaussian processes, deep learning architectures, support vector machines, data-driven regression models, k nearest neighbor classifiers, physical models or decision trees are able to be trained in this way.

In the case of the first machine learning module NN1, the latter—as already mentioned above—is supplied with state datasets S and action datasets A from the training data as input data. For a respective pair (S, A) of input datasets, the first machine learning module NN1 outputs an output dataset OS′ as the predicted subsequent state dataset and an output dataset OR as the predicted performance value. The aim of the training of the first machine learning module NN1 is for the output datasets OS′ to match the actual subsequent state datasets S′ and for the output datasets OR to match the actual performance values R as well as possible.

To this end, a divergence DI between the output datasets (OS′, OR) and the corresponding datasets (S′, R) contained in the training data is ascertained. The divergence DI in this instance can be regarded as a reproduction error or prediction error of the first machine learning module NN1. The reproduction error DI can be ascertained in particular by calculating a Euclidean distance between the respective vectors to be represented, e.g., in accordance with D1=(OS′−S′)²+(OR−R)².

As indicated by a dashed arrow in FIG. 2, the reproduction error DI is fed back to the first machine learning module NN1. The fed-back reproduction error DI is used to train the first machine learning module NN1 to minimize the reproduction error DI at least on average. A large number of efficient optimization methods are available for minimizing the reproduction error D1. The minimization of the reproduction error trains the first machine learning module NN1 to predict a resulting subsequent state and a resulting performance value for a predefined state and a predefined control action as well as possible.

FIG. 3 illustrates a training of a second machine learning module NN2 for the technical system TS. The second machine learning module NN2 may be implemented in the control device CTL or wholly or in part externally thereto. In the present exemplary embodiment, the second machine learning module NN2 is implemented as an artificial neural network, in particular as a so-called feedforward network. The second machine learning module NN2 can be trained in a data-driven manner and is intended to be trained using the training datasets TD stored in the database DB to use a respective state to predict an associated control action.

To this end, the second machine learning module NN2 is supplied with the state datasets S contained in the training datasets TD as input data, from which the second machine learning module NN2 derives output data OA. The second machine learning module NN2 is intended to be trained in such a way that the output data OA derived from a respective state dataset S of a respective training dataset TD reproduce the respective action dataset A contained in the same training dataset TD as accurately as possible at least on average. To this end, a divergence D2 between the output datasets OA and the corresponding action datasets A is ascertained. The divergence D2 can be regarded as a reproduction error of the second machine learning module NN2. The reproduction error D2 can be ascertained in particular by calculating a Euclidean distance between the respective vectors to be represented, e.g., in accordance with D2=(OA−A)².

As indicated by a dashed arrow in FIG. 3, the reproduction error D2 is fed back to the second machine learning module NN2. The fed-back reproduction error D2 is used to train the second machine learning module NN2 to minimize this reproduction error D2 at least on average. The same optimization methods can be used in this instance as in the case of the first machine learning module NN1.

The minimization of the reproduction error D2 trains the second machine learning module NN2 to output an associated control action for a predefined state.

FIG. 4 illustrates an ascertainment of a performance of a control agent P by a performance evaluator PEV. The performance evaluator PEV comprises the machine learning modules NN1 and NN2, which are trained as described above.

To illustrate successive processing steps, FIG. 4 schematically depicts multiple instances of the trained machine learning modules NN1 and NN2. The different instances can correspond in particular to different calls or analyses of routines, by which the machine learning modules NN1 and NN2 are implemented.

To evaluate the performance of the control agent P, state datasets S are fed into the control agent P as input data. Resultant output data A of the control agent P, which can be regarded as action datasets, are then transferred to the performance evaluator PEV together with the corresponding state datasets S.

The performance evaluator PEV uses the trained machine learning modules NN1 and NN2 to predict for a respective pair (S, A) of a state dataset S and an action dataset A an overall performance RET that quantifies a performance of the technical system TS, accumulated over multiple time steps in the future, that results from application of the control action A. An overall performance such as this is frequently also referred to as a “return” in the technical field of machine learning, in particular reinforcement learning.

The overall performance RET is ascertained by feeding the respective action dataset A together with the respective state dataset S into the trained first machine learning module NN1, which predicts a subsequent state therefrom and outputs a subsequent state dataset S′, specifying the subsequent state, and an associated performance value R. The subsequent state dataset S′ is in turn fed into the trained second machine learning module NN2, which derives an action dataset A′ for the subsequent state therefrom. The action dataset A′ is fed, together with the respective subsequent state dataset S′, into another instance of the first machine learning module NN1, which predicts a further subsequent state therefrom and outputs a subsequent state dataset S″, specifying the further subsequent state, and an associated performance value R′.

The above method steps can be iteratively repeated, performance values being ascertained for further subsequent states. The iteration can be terminated when a termination condition is present, e.g., when a predefined number of iterations is exceeded. In this way, a control trajectory comprising multiple time steps and progressing from subsequent state to subsequent state can be ascertained with associated performance values R, R′, R″, . . . .

The ascertained performance values R, R′, R″, . . . are supplied to a performance function PF.

The performance function PF ascertains for a respective control trajectory the overall performance RET accumulated over the control trajectory. The ascertained overall performance RET is then assigned to the control action, here A, at the start of the control trajectory. The overall performance RET thus evaluates an ability of the control agent P to ascertain a favorable, performance-optimizing control action, here A, for a respective state dataset S. The overall performance RET is calculated by the performance function PF as a performance discounted over the future time steps of a control trajectory.

To this end, the performance function PF calculates a weighted sum of the performance values R, R′, R″, . . . , the weights of which are multiplied by a discounting factor W<1 with every time step into the future. This allows the overall performance RET to be calculated in accordance with RET=R+R′*W+R″*W²+ . . . . For the discounting factor W it is possible to use e.g., a value of 0.99 or 0.9.

Finally, the predicted overall performance RET is output by the performance evaluator PEV as an evaluation result.

FIG. 5 illustrates an optimization of control agents for the technical system TS. To this end, the control device CTL is supplied with a multiplicity of training datasets TD, which are initially used to train the machine learning modules NN1 and NN2, as described above.

The control device CTL further has a model generator MG for generating deterministic control agents. The latter are implemented as artificial neural networks. The control agents are specified as such by way of a link structure for their neurons and by way of weights of connections between the neurons. A respective control agent can thus be generated by the model generator MG by generating and outputting a set of neural weights and/or a dataset indicating neuron linking. For the present exemplary embodiment, it will be assumed that the model generator MG generates the different deterministic control agents in the form of different sets of neural weights.

Generation of the control agents involves a comparison CMP1 being carried out between different generated control agents. This comparison CMP1 results in a distance between the control agents in question being ascertained that quantifies a dissimilarity or similarity between the control agents in question. In an embodiment, the distance calculated is an optionally weighted Euclidean distance between the neural weights of the compared control agents. On the basis of the ascertained distances, the model generator MG outputs those control agents that have a greater distance from other generated or output control agents. This allows control agents to be output that have a high level of diversity or dissimilarity. This fundamentally permits better exploration of regions of a state space of the technical system TS that have less coverage by training data. Other methods for generating control agents having high diversity are known e.g., from the publication “Promoting Diversity in Particle Swarm Optimization to Solve Multimodal Problems” by Cheng S., Shi Y. and Qin Q. in Neural Information Processing (eds: Lu B L., Zhang L., Kwok J.), ICONIP 2011, Lecture Notes in Computer Science, vol. 7063, Springer, Berlin, Heidelberg, (https://doi.org/10.1007/978-3-642-24958-7_27).

In the present exemplary embodiment, the model generator MG generates a multiplicity of different deterministic control agents P1, P2, . . . . The generated control agents P1, P2, . . . are supplied with a multiplicity of state datasets S of the training data as input data. For a respective state dataset S, the control agent P1 outputs a respective action dataset A1 and the control agent P2 outputs a respective action dataset A2. The other generated control agents analogously output further action datasets.

A respective action dataset A1 of the control agent P1 is fed into the performance evaluator PEV, which predicts an overall performance value RET1 for this action dataset A1, as described above. Analogously, the performance evaluator PEV ascertains a respective associated overall performance value RET2 for a respective action dataset A2. Action datasets of other generated control agents are processed analogously.

The predicted overall performance values RET1, RET2 . . . are fed into a selection module SEL of the control device CTL by the performance evaluator PEV. The selection module SEL serves the purpose of selecting performance-optimizing control agents SP1, . . . , SPK from the generated control agents P1, P2, . . . .

To this end, the selection module SEL is also supplied with the control agents P1, P2, . . . and the trained machine learning module NN2 in the form of the neural weights thereof (not depicted). The neural weights are used by the selection module SEL to perform a comparison CMP2 between a respective control agent P1, P2, . . . and the trained machine learning module NN2. This comparison CMP2 results in a distance between a respective control agent P1, P2, . . . and the trained machine learning module NN2 being ascertained that quantifies a dissimilarity or similarity between the respective control agent P1, P2, . . . and the trained machine learning module NN2.

The ascertained distances are each compared with a predefined threshold value TH. If a respective distance exceeds the threshold value TH, the control agent in question is excluded from the selection by the selection module SEL. In this way, only those of the control agents P1, P2, . . . that do not differ all too much from the trained machine learning module NN2 and therefore have a similar control response are selected. If the trained machine learning module NN2 is trained to output control actions stored in the training data, control actions that output inadmissible or seriously disadvantageous control actions can therefore be excluded.

From the remaining set of control agents similar to the machine learning module NN2, the selection module SEL continues to select those control agents that have the greatest overall performance values at least on average. In the present exemplary embodiment, a number of K control agents SP1, . . . SPK with the highest performance levels are thus selected and output by the selection module SEL.

The selected control agents SP1, . . . SPK are then used, as explained in connection with FIG. 1, to control the technical system TS. The selected control agents SP1, . . . SPK can undertake control of the technical system TS in particular alternately and/or cyclically in this case. If the selected control agents SP1, . . . SPK are deterministic control agents, the technical system TS is controlled deterministically, which considerably simplifies validation of the control compared with a stochastic control. At the same time, the diversity of the selected control agents SP1, . . . SPK permits efficient exploration of the state space or action space of the technical system TS.

During the control of the technical system TS by the selected control agents SP1, . . . SPK, the sensor system SK and optionally additional detection devices detect further state datasets ES, action datasets EA, subsequent state datasets ES′ and performance values ER for the technical system TS and add them to the training data in the database DB.

The thus augmented training data are then used to iteratively repeat the training of the machine learning modules NN1 and NN2, the generation and selection of the deterministic control agents based thereon and the augmentation of the training data. The selected control agents SP1, . . . SPK can be transferred to the model generator MG in order to drive the generation of control agents in the next iteration step in the direction of the selected control agents SP1, . . . SPK as part of a genetic or population-based optimization method. Furthermore, the threshold value TH can be gradually increased from repetition to repetition in order to develop larger regions of the state space or control action space of the technical system TS. This allows the state space or control action space to be efficiently explored and enriched with operationally relevant training data.

In particular, the above iteration can run alongside normal operation of the technical system TS in order to continually adapt control agents to environment-related or wear-related changes to the technical system TS in an optimized manner. In addition, the training data can thus be continually augmented in a manner representative of these changes.

Besides a selection of the control agents P1, P2, . . . , the control agents can also be trained, using the training datasets TD, during operation to ascertain a performance-optimizing control action, in the form of an action dataset, for a respective fed-in state dataset S. To this end—as indicated by dashed arrows in FIG. 5—the overall performance values RET1 can be fed back to the control agent P1 and the overall performance values RET2 can be fed back to the control agent P2. The same applies to other generated control agents.

The processing parameters, here the neural weights of a respective control agent P1, P2, . . . , are each adjusted, or configured, such that the respective overall performance values are maximized at least on average. The training can be performed in concrete terms using a multiplicity of efficient standard methods. The training described above allows the performance of the selected control agents SP1, . . . SPK to be improved further in many cases.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for controlling a technical system, wherein
a) reading in training data, a respective training dataset comprising a state dataset that specifies a state of the technical system, an action dataset that specifies a control action, and a performance value of the technical system that results from an application of the control action,
b) training a first machine learning module, using the training data, to use a state dataset and an action dataset to reproduce a resulting performance value,
c) supplying a multiplicity of different deterministic control agents with state datasets, and resulting output data are fed into the trained first machine learning module as action datasets,
d) taking performance values output by the trained first machine learning module as a basis for selecting multiple instances of the control agents,
e) respectively controlling the technical system by the selected control agents, with further state datasets, action datasets and performance values being captured and added to the training data, and
f) repeating method steps b) to e) using the augmented training data.

2. The method as claimed in claim 1, wherein
a second machine learning module is trained, or is trained using the training data, to use a state dataset to reproduce an action dataset,
the control agents are each compared with the second machine learning module, a respective distance that quantifies a dissimilarity between the respective control agent and the second machine learning module being ascertained, and
a control agent having a lesser distance from the second machine learning module is selected preferentially over a control agent having a greater distance.

3. The method as claimed in claim 2, wherein the distance of a respective control agent is compared with a threshold value, and in that the respective control agent is excluded from the selection if the threshold value is exceeded.

4. The method as claimed in claim 3, wherein the threshold value is increased when the method steps are repeated.

5. The method as claimed in claim 2, wherein the second machine learning module and the control agents are artificial neural networks, and
in that a divergence between neural weights of the second machine learning module and neural weights of a respective control agent is ascertained and is quantified by the respective distance.

6. The method as claimed in claim 1, wherein
the multiplicity of control agents are generated by a model generator,
multiple instances of the generated control agents are compared with other control agents, a respective distance that quantifies a dissimilarity between the compared control agents being ascertained, and
a control agent having a greater distance from one or more other control agents is selected preferentially over a control agent having a lesser distance.

7. The method as claimed in claim 1, wherein
the control agents are trained, using the training data, to use a state dataset to reproduce an action dataset that specifies a performance-optimizing control action.

8. The method as claimed in claim 1, wherein
a respective training dataset comprises a subsequent state dataset that specifies a subsequent state of the technical system resulting from an application of a control action,
the first machine learning module is trained, using the training data, to use a state dataset(S) and an action dataset to reproduce a resulting subsequent state dataset,
a second machine learning module is trained, using the training data, to use a state dataset to reproduce an action dataset,
the trained first machine learning module ascertains a subsequent state dataset for an action dataset output by the respective control agent and feeds the subsequent state dataset into the trained second machine learning module,
a resultant subsequent action dataset is fed into the trained first machine learning module together with the subsequent state dataset, and
a resultant performance value for the subsequent state is taken into consideration for the selection of the control agents.

9. The method as claimed in claim 1, wherein
the control agents are selected and/or generated using a population-based optimization method, a gradient-free optimization method, a particle swarm optimization and/or a genetic optimization method.

10. The method as claimed in claim 1, wherein the first machine learning module, a second machine learning module and/or the control agents comprise an artificial neural network, a recurrent neural network, a convolutional neural network, a multilayer perceptron, a Bayesian neural network, an autoencoder, a variational autoencoder, a Gaussian process, a deep learning architecture, a support vector machine, a data-driven trainable regression model, a k nearest neighbors classifier, a physical model and/or a decision tree.

11. The method as claimed in claim 1, wherein the technical system is a gas turbine, a wind turbine, a steam turbine, a chemical reactor, a milling machine, a machine tool, a production plant, a factory, a robot, a motor, a cooling plant, a heating plant or another machine, another device or another plant.

12. A control device for controlling a technical system, configured to carry out a method as claimed in claim 1.

13. A computer program product, comprising a computer readable hardware storage device having computer readable program code stored therein, said program code executable by a processor of a computer system to implement a method as claimed in claim 1.

14. A computer-readable storage medium having a computer program product as claimed in claim 13.
